(19) United States
(12) Patent Application Publication
(10) Pub. No.: US 2012/0272937 A1
(43) Pub. Date: Nov. 1, 2012

(54) INTERNAL COMBUSTION ENGINE

(75) Inventor: Takeshi Ashizawa, Yokohama-shi (JP)

(73) Assignee: TOYOTA JIDOSHA KABUSHIKI KAISHA, Toyota-shi, Aichi-ken (JP)

(21) Appl. No.: 13/509,860

(22) PCT Filed: Jan. 14, 2011
(86) PCT No.: PCT/JP2011/051025

§ 371 Date: May 15, 2012

(51) Int. Cl. F02D 15/04

(52) U.S. Cl. 123/48 R

(57) ABSTRACT

An internal combustion engine is provided with a variable volume device which changes the volume of a combustion chamber by compression of a gas spring when the pressure of the combustion chamber reaches a control pressure, a pressure changing device which changes a pressure of the gas of the gas spring, and a volume changing device which changes a volume of a compression space in which the gas of the gas spring is compressed. The internal combustion engine detects the operating state and performs control to reduce the pressure of the gas of the gas spring and reduce the volume of the compression space the larger the combustion rate of the fuel in the combustion chamber.

### TECHNICAL FIELD

The present invention relates to an internal combustion engine.

### BACKGROUND

An internal combustion engine supplies a combustion chamber with fuel and air and burns the fuel in the combustion chamber to output a drive force. When burning fuel in the combustion chamber, the air-fuel mixture of the air and fuel is compressed in state. It is known that the compression ratio of the internal combustion engine has an effect on the output and fuel consumption. By raising the compression ratio, it is possible to increase the output torque or reduce the fuel consumption. In this regard, if making the compression ratio extremely high, it is known that abnormal combustion occurs in the combustion chamber.

Japanese Patent Publication (A) No. 2000-230439 discloses a self-ignition type internal combustion engine which provides a combustion chamber with a sub chamber which is communicated through a pressure regulator, wherein the pressure regulator has a valve element and a valve shaft which is connected to the valve element and is biased to the combustion chamber side. It is disclosed that this self igniting type internal combustion engine pushes up the pressure regulator against the pressure of an elastic member and releases the pressure to the sub chamber when overly early ignition etc. causes the combustion pressure to exceed a predetermined allowable pressure value. This publication discloses a pressure regulator which operates by a pressure larger than the pressure which occurs due to overly early ignition etc. Further, in this publication, an internal combustion engine is disclosed where a sub chamber is formed which communicates with the combustion chamber and a sub piston is inserted able to move vertically in the sub chamber. The sub piston is pressed against by a mechanical spring. It is disclosed that when the fuel is burned, the pressure of the combustion chamber causes the mechanical spring to be compressed and the sub piston to rise and the volume of the sub chamber which communicates with the combustion chamber becomes larger.

### CITATION LIST

### Patent Literature

### PLT 1: Japanese Patent Publication (A) No. 2000-230439

### SUMMARY OF INVENTION

### Technical Problem

In a device controlling the pressure of a combustion chamber when fuel is burned, as the member which is compressed when the pressure of the combustion chamber rises, in addition to the mechanical spring which is disclosed in the above Japanese Patent Publication (A) No. 2000-230439, a gas spring in which a gas is sealed can be employed. A gas spring can easily handle the high pressure of a combustion chamber by raising the gas pressure at the inside. That is, by employing a gas spring, it is possible to easily strengthen the elasticity.

In this regard, in a device controlling the pressure of a combustion chamber, when reaching the pressure at which the sub piston should move, it is preferable that the sub piston immediately move and the rise in the pressure of the combustion chamber be suppressed. In this regard, in actuality, the sub piston has inertia, so a delay in response occurs in movement of the sub piston. In the time period in which a response delay occurs, the pressure of the combustion chamber continues to rise, so sometimes the actual pressure of the combustion chamber becomes higher than the desired pressure. For example, sometimes, due to the delay in response of the sub piston after ignition in the combustion chamber, the pressure of the combustion chamber continues to rise and as a result the pressure at which abnormal combustion occurs ends up being reached.

By increasing the area of the sub piston receiving the pressure of the combustion chamber, it is possible to improve the response of movement of the sub piston. However, in an internal combustion engine, there are limits to the size of the space for placement of the device for controlling the pressure of the combustion chamber. There was therefore the problem that it was hard to increase the pressure receiving area of the sub piston.

The present invention has as its object the provision of an internal combustion engine which is provided with a device which controls the pressure of a combustion chamber and which enables the pressure of a combustion chamber to be made to precisely approach a target pressure.

### Solution to Problem

The internal combustion engine of the present invention comprises a variable volume device which includes a gas spring which has elasticity due to a gas being compressed and which, when the pressure of a combustion chamber reaches a predetermined control pressure, uses the change in pressure of the combustion chamber as a drive source so that the gas spring is compressed whereby the volume of the combustion chamber or the volume of a space communicated with the combustion chamber changes, a pressure changing device which changes a pressure of the gas of the gas spring, and a volume changing device which changes a volume of a compression space in which the gas of the gas spring is compressed. The operating state of the internal combustion engine is used as the basis to estimate a combustion rate of fuel in the combustion chamber. The pressure of the gas of the gas spring is reduced and the volume of the compression space is made smaller the larger the combustion rate of the fuel in the combustion chamber.

In the above invention, the engine detects the operating state of the international combustion engine, selects a target pressure which a combustion chamber should reach in accordance with the operating state, and reduces the pressure of the gas of the gas spring so that a maximum value of the pressure of the combustion chamber becomes substantially the target pressure.

In the above invention, the variable volume device includes a tubular part which is communicated with the combustion chamber and a movement member which is arranged movably inside of the tubular part, the movement member defines a space at the inside of the tubular part whereby a sub chamber is formed at the side facing the combustion chamber and whereby a gas chamber is formed as a compression space at the opposite side from the side facing the combustion chamber, and the pressure changing device is connected to the gas spring so as to change the pressure of the gas chamber.

In the above invention, the volume changing device includes a gas tank which is connected to the gas chamber and a shutoff valve which is arranged in a flow path between the gas chamber and the gas tank. The shutoff valve can be operated to change the volume of the compression space of the gas spring.

In the above invention, preferably the pressure changing device includes an isolation valve for isolating the gas spring, and control is performed to close the isolation valve in the time period during which the gas spring is compressed.

### Advantageous Effects of Invention

According to the present invention, it is possible to provide an internal combustion engine which is provided with a device which controls the pressure of a combustion chamber and which enables the pressure of a combustion chamber to be made to precisely approach a target pressure.

### BRIEF DESCRIPTION OF DRAWINGS

FIG. 1 is a schematic view of an internal combustion engine in an Embodiment 1.

FIG. 2 is a schematic view of a variable volume device and volume changing device and pressure changing device of an internal combustion engine in an Embodiment 1.

FIG. 3 is a graph which shows the relationship between a crank angle and a pressure of a combustion chamber in an internal combustion engine in an Embodiment 1.

FIG. 4 is a graph which explains an ordinary operation and an operation in which the control pressure is reduced in an internal combustion engine in an Embodiment 1.

FIG. 5 is a graph which explains an operation for lowering the control pressure and an operation when lowering the control pressure and further reducing the compression space of the gas spring in an internal combustion engine in an Embodiment 1.

FIG. 6 is a flow chart of operational control in an Embodiment 1.

FIG. 7 is a schematic view of an internal combustion engine provided with another volume changing device in an Embodiment 1.

FIG. 8 is a schematic view of an internal combustion engine in an Embodiment 2.

FIG. 9 is a flow chart of operational control in an Embodiment 2.

FIG. 10 is a graph which explains an operating state of an internal combustion engine in an Embodiment 2.

### DESCRIPTION OF EMBODIMENTS

### Embodiment 1

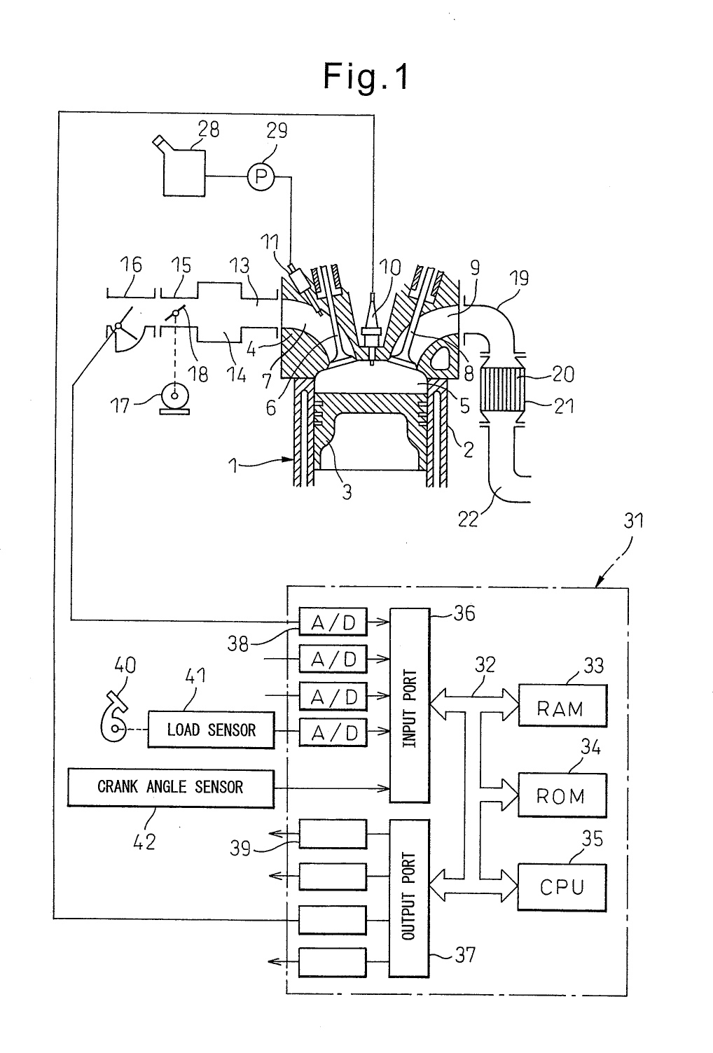

Referring to FIG. 1 to FIG. 7, an internal combustion engine in an embodiment will be explained. In the present embodiment, the explanation will be given with reference to the example of an internal combustion engine which is mounted in a vehicle.

FIG. 1 is a schematic view of an internal combustion engine in the present embodiment. The internal combustion engine in the present embodiment is a spark ignition type. The internal combustion engine is provided with an engine body 1. The engine body 1 includes a cylinder block 2 and cylinder head 4. Inside the cylinder block 2, pistons 3 are arranged. In the present invention, the space inside a cylinder surrounded by the crown surface of the piston and the cylinder head when the piston reaches compression top dead center and the space inside of the cylinder surrounded by the crown face of the piston and the cylinder head at any position will be called the “combustion chamber”. The top face of the combustion chamber 5 is formed by the cylinder head 4, while the bottom face of the combustion chamber 5 is formed by the crown face of the piston 3.

A combustion chamber 5 is formed for each cylinder. Each combustion chamber 5 is connected to an engine intake passage and an engine exhaust passage. At the cylinder head 4, an intake port 7 and exhaust port 9 are formed. An intake valve 6 is arranged at an end of the intake port 7 and is formed to be able to open and close the engine intake passage which is communicated with the combustion chamber 5. An exhaust valve 8 is arranged at an end of the exhaust port 9 and is formed to be able to open and close the engine exhaust passage which is communicated with the combustion chamber 5. At the cylinder head 4, a spark plug 10 serving as an ignition device is fastened. The spark plug 10 is formed to ignite the fuel in the combustion chamber 5.

The internal combustion engine in the present embodiment is provided with a fuel injector 11 for feeding fuel to each combustion chamber 5. The fuel injector 11 in the present embodiment is arranged so as to inject fuel to the intake port 7. The fuel injector 11 is not limited to this. It is sufficient that it be arranged to be able to feed fuel to the combustion chamber 5. For example, the fuel injector may be arranged so as to directly inject fuel to the combustion chamber.

The fuel injector 11 is connected to a fuel tank 28 through an electronic control type variable discharge fuel pump 29. The fuel which is stored in the fuel tank 28 is supplied to the fuel injector 11 by the fuel pump 29.

The intake port 7 of each cylinder is connected through a corresponding intake runner 13 to a surge tank 14. The surge tank 14 is connected through an intake duct 15 and air flowmeter 16 to an air cleaner (not shown). At the intake duct 15, the air flowmeter 16 is arranged to detect the amount of intake air. At the inside of the intake duct 15, a throttle valve 18 which is driven by a step motor 17 is arranged. On the other hand, the exhaust port 9 of each cylinder is connected to a corresponding exhaust runner 19. The exhaust runner 19 is connected to a catalytic converter 21. The catalytic converter 21 in the present embodiment includes a three-way catalyst 20. The catalytic converter 21 is connected to an exhaust pipe 22.

The internal combustion engine in the present embodiment is provided with an electronic control unit 31. The electronic control unit 31 in the present embodiment includes a digital computer. The electronic control unit 31 includes components connected to each other through a bidirectional bus 32 such as a RAM (random access memory) 33, ROM (read only memory) 34, CPU (microprocessor) 35, input port 36, and output port 37.

The air flowmeter 16 generates an output voltage which is proportional to the amount of intake air which is taken into each combustion chamber 5. This output voltage is input to the input port 36 through a corresponding AD converter 38. An accelerator pedal 40 has a load sensor 41 connected to it. The load sensor 41 generates an output voltage which is proportional to the amount of depression of the accelerator pedal 40. This output voltage is input through a corresponding AD converter 38 to the input port 36.

A crank angle sensor 42 generates an output pulse every time a crankshaft for example turns by a predetermined angle. This output pulse is input to the input port 36. The output of the crank angle sensor 42 may be used to detect the engine speed. Further, the output of the crank angle sensor 42 may be used to detect the crank angle.

The output port 37 of the electronic control unit 31 is connected through corresponding drive circuits 39 to each fuel injector 11 and spark plug 10. The electronic control unit 31 in the present embodiment is formed so as to control fuel injection and control ignition. That is, the timing of injection of fuel and the amount of injection of fuel are controlled by the electronic control unit 31. Further the ignition timing of each spark plug 10 is controlled by the electronic control unit 31. Further, the output port 37 is connected through the corresponding drive circuits 39 to the step motor 17 for driving the throttle valve 18 and the fuel pump 29. These devices are controlled by the electronic control unit 31.

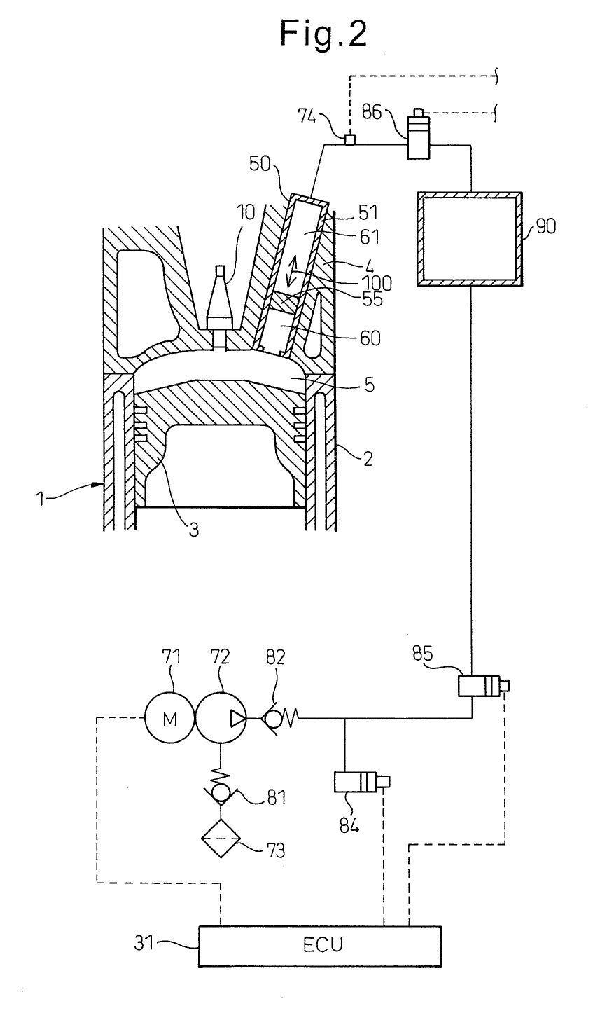

FIG. 2 shows a schematic cross-sectional view of a variable volume device, volume changing device, and pressure changing device in an internal combustion engine in the present embodiment. The internal combustion engine in the present embodiment is provided with a combustion pressure control system which controls the pressure of each combustion chamber when the fuel is burned. The combustion pressure control system in the present embodiment is provided with a variable volume device by which the volume of the space communicated with the combustion chamber changes. The variable volume device includes a gas spring 50. The gas spring 50 is connected to each combustion chamber 5 in each cylinder. The internal combustion engine in the present embodiment has a sub chamber 60 as the space which is communicated with each combustion chamber 5.

The variable volume device in the present embodiment uses the pressure change of each combustion chamber 5, when the pressure of the combustion chamber 5 reaches the control pressure, as the drive source to change the volume of the sub chamber 60. That is, the variable volume device operates by the change of pressure of the combustion chamber 5. The control pressure in the present invention is a pressure of the combustion chamber when the variable volume device starts to operate. That is, this is the pressure of the combustion chamber when the sub chamber-use piston 55 starts to move. The variable volume device keeps the pressure of the combustion chamber 5 from becoming the pressure of occurrence of abnormal combustion or more.

The abnormal combustion in the present invention, for example, includes combustion other than the state when an ignition device ignites the air-fuel mixture and the combustion successively propagates from the ignition point. Abnormal combustion includes, for example, the knocking phenomenon, detonation phenomenon, and preignition phenomenon. The knocking phenomenon includes the spark knock phenomenon. The spark knock phenomenon is the phenomenon where fuel is ignited in a spark device, the flame spreads centered from the ignition device, and the air-fuel mixture including unburned fuel at the position furthest from the ignition device self ignites. The air-fuel mixture at the position furthest from the ignition device is compressed by the combustion gas near the ignition device, becomes high temperature and high pressure, and self ignites. When the air-fuel mixture self ignites, a shock wave is generated.

The detonation phenomenon is the phenomenon where the air-fuel mixture ignites due to a shock wave passing through the high temperature, high pressure air-fuel mixture. This shock wave is, for example, generated due to the spark knock phenomenon. The preignition phenomenon is also called the “early ignition phenomenon”. The preignition phenomenon is the phenomenon of metal at the tip of a spark plug or carbon sludge etc. deposited inside a combustion chamber being heated to a predetermined temperature or more and, in the state maintaining that, this part becoming the spark for ignition and burning of fuel before the ignition timing.

The variable volume device in the present embodiment is provided with a tubular member 51 forming each tubular part. The tubular member 51 in the present embodiment is formed into a cylindrical shape. Inside of the tubular member 51, a sub chamber-use piston 55 is arranged as the movement member. The space inside of the tubular member 51 is divided by the sub chamber-use piston 55. Inside of the tubular member 51, a sub chamber 60 is formed at the side facing the combustion chamber 5. Further, inside of the tubular member 51, a gas chamber 61 is formed at the side opposite to the side facing the combustion chamber 5.

Each sub chamber-use piston 55 is not fixed to the tubular member 51 but is formed so as to move in the axial direction of the tubular member 51. The sub chamber-use piston 55, as shown by the arrow 100, moves inside of the tubular member 51. The sub chamber-use piston 55 contacts the tubular member 51 through piston rings serving as sealing members. Due to the movement of the sub chamber-use piston 55, the volume of the sub chamber 60 changes. The combustion gas flows to the sub chamber 60.

The gas spring 50 of the variable volume device in the present embodiment is formed to have elasticity by sealing gas inside. The gas chamber 61 of the gas spring 50 is filled with pressurized gas so that the sub chamber-use piston 55 starts to move when the pressure of the combustion chamber 5 reaches the desired control pressure. In the present embodiment, the gas chamber 61 is charged with air. The gas which is charged to the gas chamber 61 is not limited to air. Any gas may be employed.

The gas spring 50 in the present embodiment has a compression space in which the gas at the inside is compressed at the time of compression. Further, the internal combustion engine in the present embodiment is provided with a volume changing device which changes the volume of the compression space. The volume changing device in the present embodiment includes a gas tank 90 which is connected to the gas chamber 61 and a shutoff valve 86. The shutoff valve 86 is arranged in the flow path between the gas chamber 61 and the gas tank 90. The volume changing device is controlled by the electronic control unit 31. The shutoff valve 86 in the present embodiment is controlled by the electronic control unit 31. By opening the shutoff valve 86, the gas chamber 61 and the gas tank 90 form the compression space. Further, by closing the shutoff valve 86, the gas chamber 61 forms the compression space.

In the internal combustion engine in the present embodiment, the compression space is closed in the time period during which the sub chamber-use piston 55 is moving, that is, in the time period during which the gas spring 5 is compressed. In the present embodiment, in the time period during which the gas spring 50 is compressed, the pressure regulator 85 is closed. By closing the pressure regulator 85, it is possible to shut the flow path which is connected to the compression space. The gas spring 50 has elasticity due to the compression space being closed. Due to the pressure of the compression space, the sub chamber-use piston 55 is pressed.

The internal combustion engine in the present embodiment is provided with a pressure changing device which changes the pressure of the compression space of the gas spring. The pressure changing device in the present embodiment is connected to the gas tank 90.

The pressure changing device in the present embodiment includes a motor 71 and a compressor 72 which is driven by the motor 71. At the outlet of the compressor 72, a check valve 82 is arranged. The check valve 82 prevents gas of the gas chamber 61 from flowing out backward. The compressor 72 is connected to the check valve 81 and filter 73. The filter 73 removes foreign matter from the air which is sucked into the compressor 72. The check valve 81 prevents the air from flowing back from the compressor 72.

The pressure changing device in the present embodiment includes a pressure sensor 74 serving as a pressure detector which detects the pressure of the compression space of the gas spring 50. The pressure sensor 74 in the present embodiment is arranged in the flow path which connects the gas chamber 61 and the shutoff valve 86.

The pressure changing device is controlled by the electronic control unit 31. In the present embodiment, the motor 71 is controlled by the electronic control unit 31. The air exhaust valve 84 and pressure regulator 85 in the present embodiment is controlled by the electronic control unit 31. The output of the pressure sensor 74 is input to the electronic control unit 31.

The internal combustion engine in the present embodiment enables charging with air even if air leaks out from the compression space of the gas spring 50 during the operating period or the idle period. For example, by using the motor 71 to drive the compressor 72 and further opening the pressure regulator 85 and the shutoff valve 86, it is possible to feed air to the gas chamber 61.

The pressure changing device in the present embodiment can raise the pressure of the compression space in the gas spring 50. Further, the pressure changing device in the present embodiment can exhaust the gas from the compression space of the gas spring 50. By opening the pressure regulator 85 and air exhaust valve 84, the pressure of the compression space can be lowered. In this way, by changing the pressure of the compression space, it is possible to change the control pressure. The pressure changing device is not limited to this. It is possible to employ any device which can change the pressure of the compression space of the gas spring.

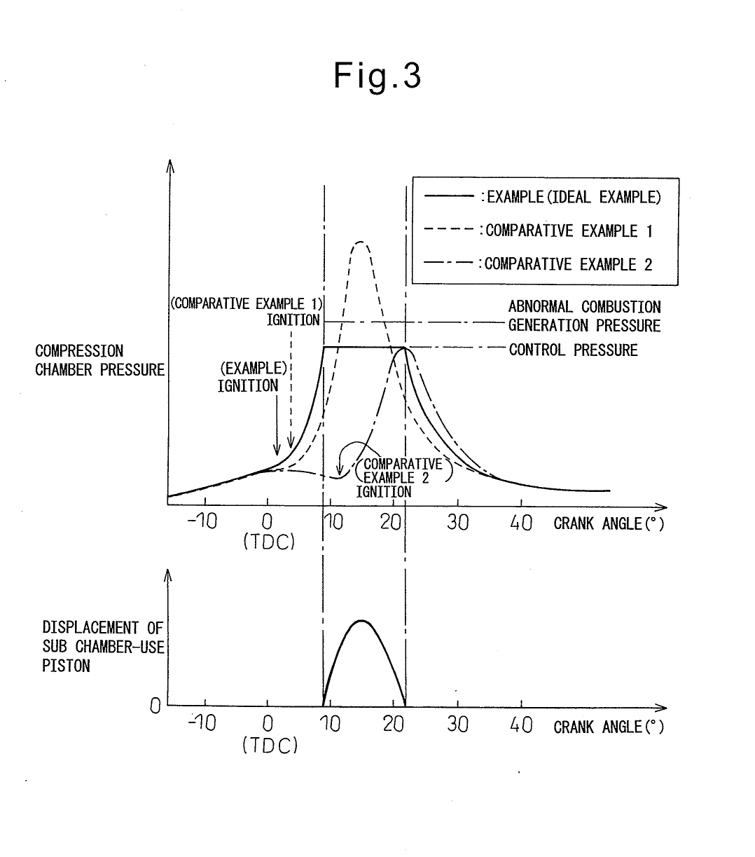

FIG. 3 shows a graph of the pressure of a combustion chamber in the internal combustion engine of the present embodiment. The abscissa indicates the crank angle, while the ordinate indicates the pressure of combustion chamber and the displacement of a sub chamber-use piston. FIG. 3 shows a graph of the compression stroke and expansion stroke in the combustion cycle. The sub chamber-use piston 55 has zero displacement when seated at the bottom of the tubular member 51. In the variable volume device in the present embodiment, the sub chamber-use piston 55 moves when the pressure of the combustion chamber reaches the control pressure in the period from the compression stroke to the expansion stroke of the combustion cycle. As a result, the volume of the sub chamber 60 of the gas spring 50 becomes larger.

Referring to FIG. 2 and FIG. 3, at the time of start of the compression stroke, the sub chamber-use piston 55 is seated at the bottom of the tubular member 51. In the compression stroke, the piston 3 rises and the pressure of the combustion chamber 5 rises. Here, in the compression space of the gas spring 50, gas of a pressure corresponding to the control pressure is sealed, so the sub chamber-use piston 55 is held in the seated state until the pressure of the combustion chamber 5 becomes the control pressure.

In the embodiment shown in FIG. 3, ignition is performed at a crank angle slightly after 0° (TDC). Due to the ignition, the pressure of the combustion chamber 5 rapidly rises. When the pressure of the combustion chamber 5 reaches the control pressure, the sub chamber-use piston 55 starts to move. If the air-fuel mixture continues burning, the gas spring 50 is compressed and the volume of the sub chamber 60 increases. For this reason, the rise of the pressure of the combustion chamber 5 and the sub chamber 60 is suppressed. In the embodiment shown in FIG. 3, the pressure of the combustion chamber 5 is held substantially constant.

If combustion of fuel continues further in the combustion chamber, the displacement of the sub chamber-use piston 55 becomes maximum, then becomes smaller. The pressure of the gas chamber 61 is decreased and the displacement of the sub chamber-use piston 55 returns to zero. That is, the sub chamber-use piston 55 returns to a seated position. When the pressure of the combustion chamber 5 becomes less than the control pressure, the pressure of the combustion chamber 5 is reduced along with the progress of the crank angle.

In this way, the combustion pressure control system in the present embodiment can suppress the rise of the pressure of a combustion chamber when the pressure of the combustion chamber 5 reaches the control pressure and can perform control so that the pressure of the combustion chamber does not become the pressure where abnormal combustion occurs and more.

FIG. 3 shows a graph of the pressure of a combustion chamber of Comparative Example 1 and Comparative Example 2. Comparative Example 1 and Comparative Example 2 are internal combustion engines which do not have the variable volume device of the present embodiment. The internal combustion engine fluctuates in the pressure of a combustion chamber in accordance with the ignition timing. The internal combustion engine has an ignition timing θmax where the output torque becomes maximum. Comparative Example 1 is a graph for when ignition is performed at the ignition timing θmax. By having the ignition performed at the ignition timing where the output torque becomes maximum, the pressure of the combustion chamber becomes high and the heat efficiency becomes the best. In this regard, if the ignition timing is advanced like in Comparative Example 1, the pressure of the combustion chamber becomes higher than the pressure where abnormal combustion occurs. The graph of Comparative Example 1 assumes that abnormal combustion does not occur. On the other hand, in an actual internal combustion engine, the ignition timing is delayed so that the maximum pressure of the combustion chamber becomes smaller than the pressure where abnormal combustion occurs.

In the internal combustion engine of Comparative Example 2, to avoid the occurrence of abnormal combustion, ignition is performed delayed from the ignition timing where the output torque becomes maximum. When delaying the ignition timing, the maximum pressure of a combustion chamber becomes smaller than the case where ignition is performed at an ignition timing where the output torque becomes maximum.

The internal combustion engine in the present embodiment can burn fuel in the state where the pressure of a combustion chamber is kept less than the pressure where abnormal combustion occurs. It is possible to suppress the occurrence of abnormal combustion even if advancing the ignition timing. In particular, it is possible to suppress abnormal combustion even in an engine with a high compression ratio. Furthermore, it is possible to increase the time when the pressure of the combustion chamber is high. For this reason, the heat efficiency is improved over that of an internal combustion engine of Comparative Example 2 which delays the ignition timing. It is possible to increase the output torque. Further, it is possible to reduce the fuel consumption.

The embodiment shown in FIG. 3 shows the ideal operating state of the variable volume device. In the embodiment shown in FIG. 3, during the time period during which the sub chamber-use piston is moving, the pressure of the combustion chamber is held constant at substantially the control pressure. In this regard, in an actual variable volume device, depending on the operating state of the internal combustion engine, sometimes overshoot occurs immediately after the pressure of the combustion chamber reaches the control pressure. Furthermore, due to movement of the sub chamber-use piston, the pressure of the compression space rises, so the pressure of the combustion chamber also rises.

Referring to FIG. 2, when the pressure of the combustion chamber 5 reaches the control pressure, the sub chamber-use piston 55 starts to move. At this time, the sub chamber-use piston 55 has inertia in accordance with its weight. For this reason, a delay in response occurs in the movement of the sub chamber-use piston 55. At the time of ordinary operation of the internal combustion engine of the present embodiment, during the time period during which the sub chamber-use piston 55 moves, control is performed to a state where the shutoff valve 86 is opened. The compression space of the gas spring 50 is comprised of the gas chamber 61 and the gas tank 90.

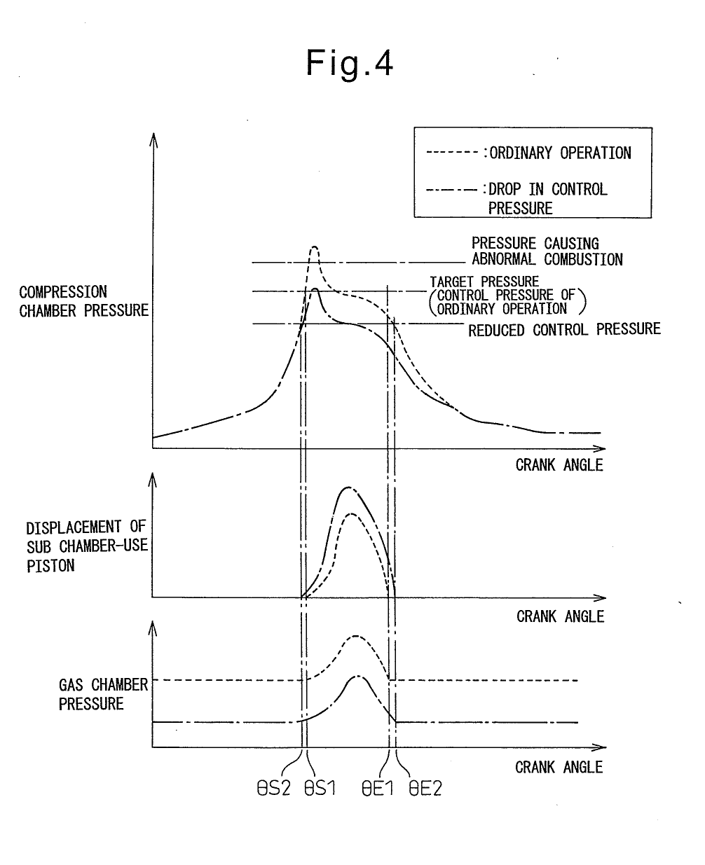

FIG. 4 shows a first graph which explains the pressure of a combustion chamber of an internal combustion engine in the present embodiment. In FIG. 4, ordinary operation is shown by the broken line, while operation which reduces the control pressure, explained later, is shown by the one-dot chain line. An example of operation where overshoot occurs right after the pressure of the combustion chamber reaches the control pressure is shown.

The target pressure is set so that the maximum pressure of the combustion chamber does not exceed the pressure at which abnormal combustion occurs under conditions where no overshoot occurs in the pressure of the combustion chamber in ordinary operation of an internal combustion engine of the present embodiment. For the target pressure of the combustion chamber in the present embodiment, the pressure at which abnormal combustion occurs minus a predetermined pressure is employed. In ordinary operation, the target pressure of the combustion chamber corresponds to the control pressure. For example, the control pressure is determined based on the engine speed and demanded load of the internal combustion engine.

In control in ordinary operation, the sub chamber-use piston 55 moves in the time period from the crank angle θS1 to the crank angle θE1. When the pressure of the combustion chamber 5 reaches the control pressure of ordinary operation, a delay in response occurs in movement of the sub chamber-use piston 55. For this reason, the pressure of the combustion chamber 5 continues to rise and overshoot occurs. Right after the sub chamber-use piston 55 starts to move, the pressure of the combustion chamber 5 greatly exceeds the target pressure.

After this, the pressure of the combustion chamber 5 is reduced along with movement of the sub chamber-use piston 55. A delay in response occurs when the sub chamber-use piston 55 moves toward the seated position. For this reason, in the time period during which displacement of the sub chamber-use piston 55 is reduced, the pressure of the combustion chamber 5 becomes smaller than the target pressure. In particular, in the latter half of the time period in which the sub chamber-use piston 55 is moving, the pressure of the combustion chamber 5 becomes smaller than the target pressure.

This delay in response becomes remarkable in the operating state where the speed of movement of the sub chamber-use piston 55 is fast. That is, it becomes remarkable in the operating state where the combustion rate in the combustion chamber 5 is fast. In the present embodiment, in the operating state where the combustion rate in the combustion chamber 5, control is performed to lower the control pressure when the sub chamber-use piston 55 starts to move. Furthermore, control is performed to reduce the volume of the compression space of the gas spring 50.

First, control for lowering the control pressure will be explained. To lower the control pressure, the pressure of the gas chamber 61 is reduced. The pressure of the compression space of the gas spring 50 is reduced. The control pressure becomes smaller than the target pressure of the combustion chamber 5. Referring to the graph of the one-dot chain line of FIG. 4, by reducing the control pressure, the maximum pressure which the combustion chamber 5 reaches becomes smaller. The time period from the crank angle θS2 to the crank angle θE2 is the time period in which the sub chamber-use piston 55 moves.

Referring to FIG. 2, when reducing the control pressure, by opening the pressure regulator 85 in the state with the air exhaust valve 84 opened, the pressure of the compression space of the gas spring 50 is lowered. By the pressure of the gas chamber 61 being lowered, the pressure of the combustion chamber 5 when the sub chamber-use piston 55 starts to move, that is, the control pressure, can be reduced.

In the example of operation shown in FIG. 4, if driving the variable volume device at the control pressure of ordinary operation, the maximum pressure of the combustion chamber 5 exceeds the pressure of occurrence of abnormal combustion. By reducing the control pressure, it is possible to keep the pressure of the combustion chamber 5 from becoming the pressure at which abnormal combustion occurs or more even if overshoot occurs in the pressure of the combustion chamber 5.

Further, since the pressure of the compression space of the gas spring 50 becomes smaller, the response of the sub chamber-use piston 55 is improved. For this reason, it is possible to reduce the extent of pressure rise due to overshoot. Furthermore, to improve the response of the sub chamber-use piston 55, it is possible to reduce the extent of pressure reduction in the latter half of the time period during which the sub chamber-use piston 55 is moving.

The amount of reduction in the control pressure is preferably set so that the maximum pressure of the combustion chamber 5 after the control pressure falls becomes less than the pressure at which abnormal combustion occurs. Further, the amount of reduction of the control pressure is preferably set so that the maximum pressure of the combustion chamber 5 after the control pressure falls becomes about the same as the target pressure.

Next, control for reducing the volume of the compression space of the gas spring will be explained.

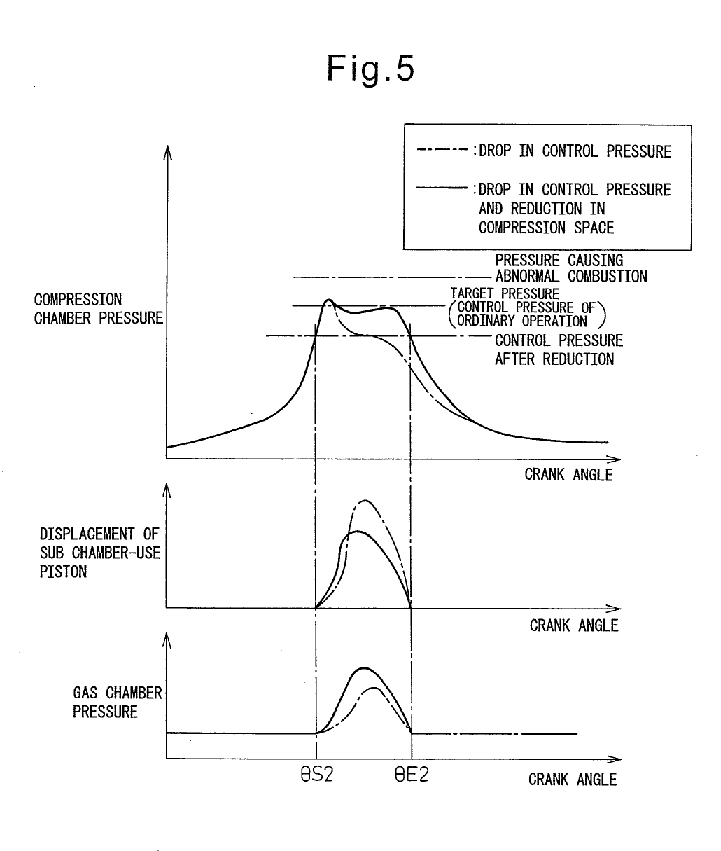

FIG. 5 is a second graph for explaining the pressure of a combustion chamber of the internal combustion engine in the present embodiment. In FIG. 5, an operation which reduces the control pressure is shown by the one-dot chain line, while an operation which reduces the control pressure and reduces the volume of the compression space is shown by the solid line.

When the pressure receiving area of the sub chamber-use piston 55 is substantially the same, by reducing the volume of the compression space, the rise of the pressure of the compression space when the sub chamber-use piston 55 moves by a unit length becomes larger. By making the volume of the compression space of the gas spring 50 smaller, the rise of the pressure of the gas chamber 61 becomes larger. For this reason, the rise of the pressure of the combustion chamber 5 in the time period during which the sub chamber-use piston 55 moves becomes larger.

Referring to FIG. 2, as the control for reducing the volume of the compression space in the present embodiment, control is performed to close the shutoff valve 86. By closing the shutoff valve 86, the gas tank 90 is isolated. The compression space of the gas spring 50 is comprised by the gas chamber 61.

As shown in FIG. 5, with just control for lowering the control pressure, the pressure of the combustion chamber approaches the target pressure at the start of the time period during which the sub chamber-use piston 55 moves. In this regard, after this, the pressure of the combustion chamber is made much less than the target pressure. Therefore, by reducing the volume of the compression space, in the time period during which the sub chamber-use piston 55 moves, the pressure of the combustion chamber 5 can be raised. It is possible to make the pressure of the combustion chamber 5 during the period in which the sub chamber-use piston 55 is moving approach the target pressure.

The control in the present embodiment for reducing the control pressure and further reducing the volume of the compression space preferably is performed in an operating state of the internal combustion engine in which the combustion rate of the fuel in the combustion chamber becomes fast. In the internal combustion engine in the present embodiment, the operating state is detected. When it is judged that the combustion rate in the combustion chamber is fast, control is performed to reduce the control pressure and further reduce the volume of the compression space.

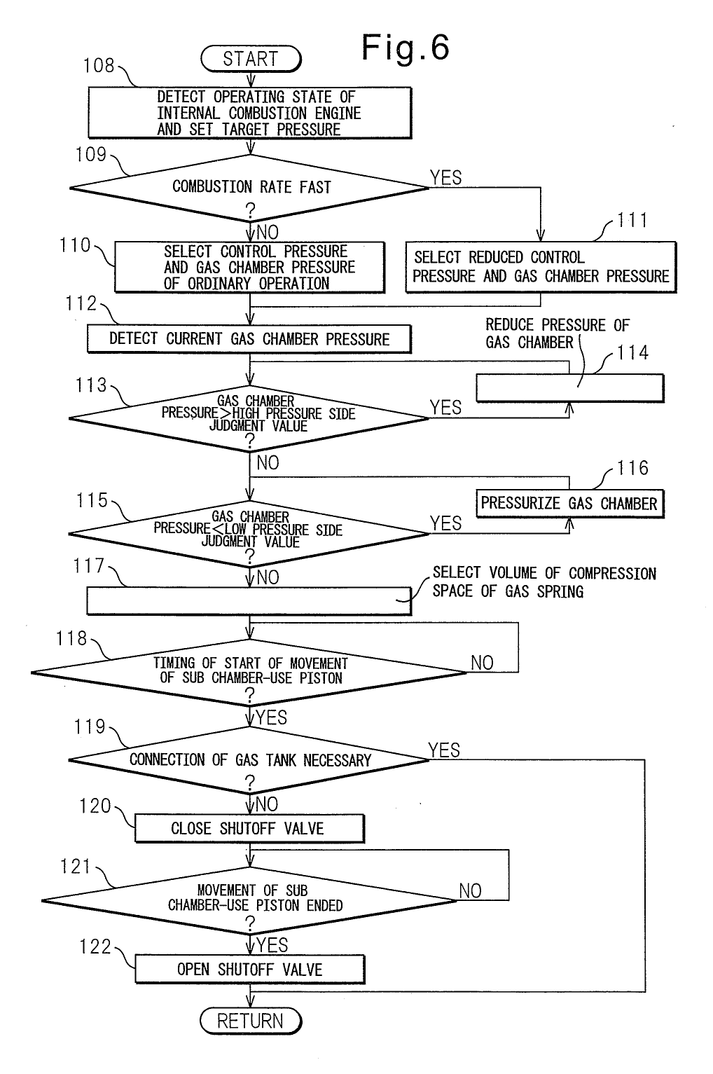

FIG. 6 shows a flow chart of operational control of the internal combustion engine in the present embodiment. The operational control shown in FIG. 6 can, for example, be performed every predetermined time interval.

First, at step 108, the operating state of the internal combustion engine is detected. In the present embodiment, the engine speed and demanded load are detected. Referring to FIG. 1, the engine speed can be detected by the output of the crank angle sensor 42. The demanded load can be detected by the output of the load sensor 41. The target pressure of the combustion chamber is set based on the operating state of the internal combustion engine. The target pressure of the combustion chamber 5 can, for example, be stored in the electronic control unit 31 in the form of a map as a function of the engine speed and demanded load.

Next, at step 109, based on the detected operating state of the internal combustion engine, it is judged if the combustion rate in the combustion chamber is fast. When it is judged at step 109 that the combustion rate in the combustion chamber is not fast, the routine proceeds to step 110. When it is judged at step 109 that the combustion rate in the combustion chamber is fast, the routine proceeds to step 111.

At step 110, the control pressure in ordinary operation is selected. For example, it is possible to select a pressure substantially equal to the target pressure of the combustion chamber 5 as the control pressure. Further, the pressure of the gas chamber 61 corresponding to the control pressure is determined. In the present embodiment, the range of the pressure of the gas chamber 61 is determined. Referring to FIG. 2, in the present embodiment, the surface area of the sub chamber-use piston 55 at the sub chamber 60 side and the surface area at the gas chamber 61 side become substantially the same, so the pressure of the gas chamber 61 becomes substantially the same as the control pressure.

At step 111, the control pressure is lowered than with ordinary operation. For example, it is possible to select the target pressure of the combustion chamber 5 minus a predetermined amount of reduction as the control pressure. Based on the selected control pressure, the pressure of the gas chamber 61 is detected. In the present embodiment, the range of the pressure of the gas chamber 61 is determined.

Next, at step 112, the current pressure of the gas chamber 61 is detected. That is, the pressure of the compression space is detected. The pressure of the gas chamber 61 can be detected by the pressure sensor 74.

Next, at step 113 and at step 115, it is judged if the pressure of the gas chamber 61 is within the selected range of the pressure of the gas chamber 61. At step 113, it is judged if the current pressure of the gas chamber 61 is larger than the high pressure side judgment value of the pressure range. If, at step 113, the current pressure of the gas chamber 61 is larger than the high pressure side judgment value, the routine proceeds to step 114.

At step 114, control is performed to reduce the pressure of the gas chamber 61. If, at step 113, the current pressure of the gas chamber 61 is the high pressure side judgment value or less, the routine proceeds to step 115.

At step 115, it is judged if the current pressure of the gas chamber 61 is less than the low pressure side judgment value of the range of pressure. If the current pressure of the gas chamber 61 is less than the low pressure side judgment value, the routine proceeds to step 116. At step 116, control is performed to pressurize the gas chamber 61. If at step 115 the current pressure of the gas chamber 61 is the low pressure side judgment value or more, the routine proceeds to step 117. In this case, the current pressure of the gas chamber 61 is in the range of the target pressure of the gas chamber 61.

Next, at step 117, the volume of the compression space of the gas spring is selected. In the present embodiment, the judgment at step 109 of whether the combustion rate of the combustion chamber is fast is used as the basis to select the volume of the compression space. In the present embodiment, when the combustion rate is fast, only the gas chamber 61 is selected as the compression space. When the combustion rate is not fast, the gas chamber 61 and gas tank 90 are selected as the compression space.

Next, at step 118, it is judged if the timing is the timing for start of movement of the sub chamber-use piston 55. The timing for start of movement of the sub chamber-use piston 55 can, for example, be judged by detecting the crank angle. If not the timing for start of movement of the sub chamber-use piston 55 at step 118, this control is repeated. If the timing for start of movement of the sub chamber-use piston 55 at step 118, the routine proceeds to step 119.

Next, at step 119, it is judged if connection of the gas tank 90 is necessary based on the judgment at step 117. At the time of ordinary operation, the shutoff valve 86 is opened in state. The gas chamber 61 and gas tank 90 form the compression space. When connection of the gas tank 90 is necessary at step 119, this control is ended. When it is judged at step 119 that connection of the gas tank 90 is unnecessary, the routine proceeds to step 120.

Next, at step 120, control is performed to close the shutoff valve 86. The compression space of the gas spring 50 is comprised of the gas chamber 61.

Next, at step 121, it is judged if movement of the sub chamber-use piston 55 has ended. During the time period during which the sub chamber-use piston 55 is moving, step 121 is repeated. That is, the closed state of the shutoff valve 86 is maintained. When it is judged at step 121 that the movement of the sub chamber-use piston has ended, the routine proceeds to step 122.

Next, at step 122, it is possible to open the shutoff valve 86 and shift to the state of ordinary operation. In this way, in the internal combustion engine of the present embodiment, it is possible to detect the operating state and, in the operating state where the combustion rate of the combustion chamber is fast, reduce the control pressure and reduce the volume of the compression space of the gas spring.

As the operating state where the combustion rate becomes fast in the combustion chamber, for example, the state of a high engine speed can be illustrated. Further, the operating state where the ignition timing in the combustion chamber is fast can be illustrated.

Further, the operating state where the exhaust gas remaining in the combustion chamber becomes smaller can be illustrated. For example, when the internal combustion engine is provided with a variable valve mechanism and there is an overlap where the intake valve and exhaust valve open simultaneously, in the operating state where the overlap time becomes long, the exhaust gas remaining inside the combustion chamber becomes small and the combustion rate becomes fast.

Further, it is possible to illustrate control for speeding up the timing of closing the intake valve. That is, it is possible to illustrate control making the timing of closing the intake valve approach bottom dead center of the piston. If speeding up the timing of closing the intake valve, the pressure of the combustion chamber at the time of ignition in the combustion chamber becomes higher. For this reason, the combustion rate becomes faster.

Further, as an operating state in which the combustion rate becomes fast, a state where the temperature of the outside air is high can be illustrated. If the temperature of the outside air is high, the temperature of the air which is sucked into the combustion chamber also becomes high. For this reason, the temperature at the time of combustion becomes higher and the combustion rate becomes faster.

Further, when the internal combustion engine is provided with a tumble control valve, it is possible to illustrate the operating state where a tumble control valve is used to promote the tumble flow in the combustion chamber. By the tumble flow being promoted, the gas inside of the combustion chamber is sufficiently stirred to facilitate combustion. For this reason, the combustion rate becomes faster.

The operating state where the combustion rate becomes faster is not limited to the above embodiments. It is possible to employ any operating state where the combustion rate at the combustion chamber becomes faster. The volume changing device in the present embodiment includes a gas tank which is connected to the gas chamber of the gas spring and a shutoff valve which is arranged in the flow path between the gas chamber and the gas tank. The device is formed so as to enable the volume of the compression space of the gas spring by operating the shutoff valve. By employing this configuration, it is possible to easily change the volume of the compression space of the gas spring. The volume changing device is not limited to this, but is it possible to employ any device which can change the volume of the compression space of the gas spring.

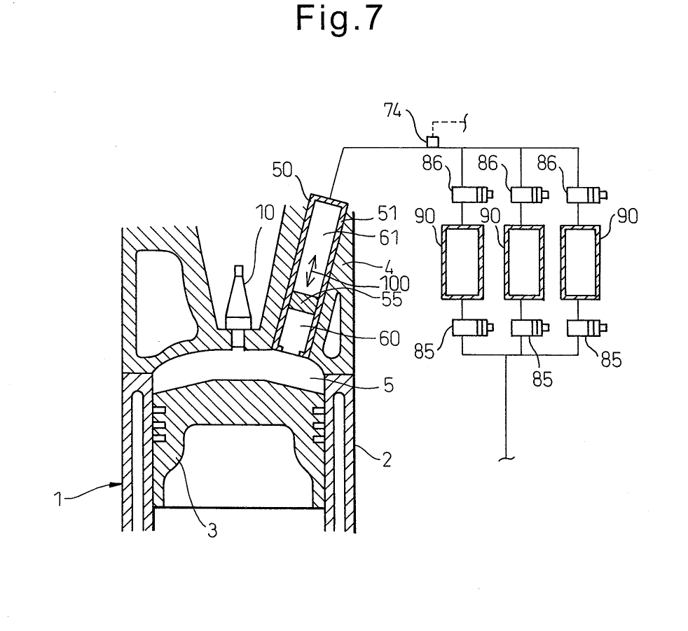

FIG. 7 is a schematic view of an internal combustion engine which is provided with another volume changing device in the present embodiment. The volume changing device is formed so that the volume of the compression space of the gas spring is changed in two stages. In this other volume changing device, the volume of the compression space can be changed in multiple stages.

The other volume changing device in the present embodiment includes a plurality of gas tanks 90. One gas chamber 61 is connected to a plurality of gas tanks 90. Pressure regulators 85 and shutoff valves 86 are arranged corresponding to these gas tanks 90. During the time period during which the sub chamber-use piston 55 is moving, all pressure regulators 85 are held in an closed state. During the time period during which the sub chamber-use piston 55 is moving, it is possible to select the number of the shutoff valves 86 opened so as to change the volume of the compression space in multiple stages.

In this way, the volume of the compression space of the gas spring can be controlled in multiple stages. Further, the amount of reduction of the control pressure can also be controlled in multiple stages by adjusting the pressure of the compression space. For this reason, the internal combustion engine can detect the operating state and perform control to gradually reduce the control pressure the faster the combustion rate in the combustion chamber and further gradually reduce the volume of the compression space of the gas spring. In this way, it is also possible to control the control pressure and the volume of the compression space of the gas spring in stages.

The variable volume device in the present embodiment is formed to enable variation of the volume of the sub chamber as a space communicated with the combustion chamber, but the invention is not limited to this. It may also be formed to enable variation of the volume of the combustion chamber. For example, the variable volume device is formed at the top of the piston forming the combustion chamber and is formed to enable variation of the volume of the combustion chamber.

In the present embodiments, the explanation was given with reference to an internal combustion engine mounted in an automobile as an example, but the invention is not limited to this. The present invention may be applied to any internal combustion engine.

### Embodiment 2

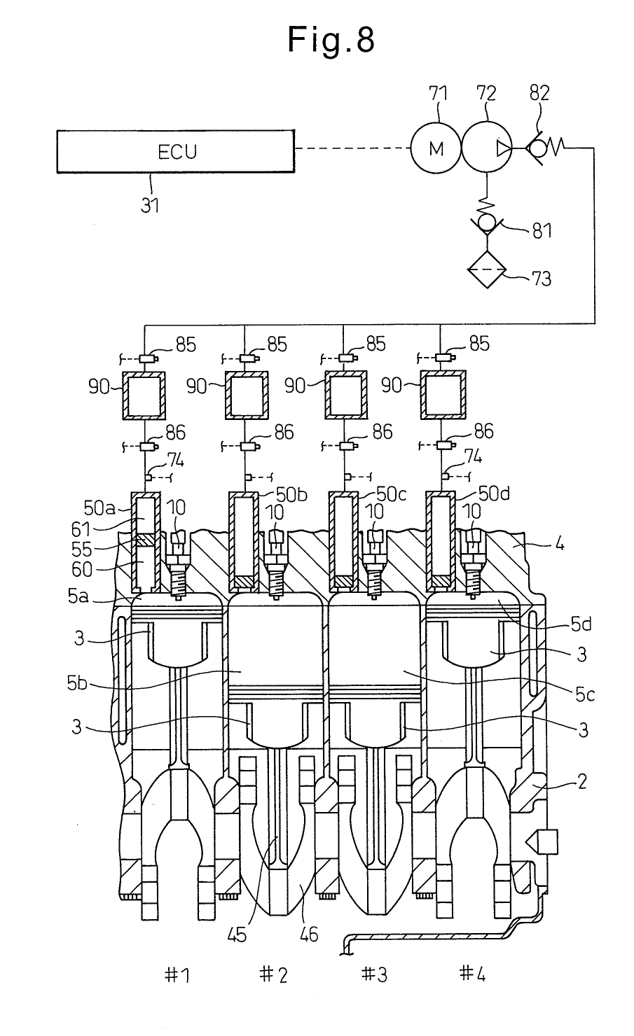

Referring to FIG. 8 to FIG. 10, an internal combustion engine in embodiment 2 will be explained. The configuration of the variable volume device in the present embodiment is similar to the configuration of the variable volume device of the internal combustion engine in the embodiment 1 (see FIG. 2). In the present embodiment, an internal combustion engine which is provided with a plurality of cylinders will be explained as an example.

FIG. 8 shows a schematic cross-sectional view of the internal combustion engine in the present embodiment. The internal combustion engine in the present embodiment has a plurality of cylinders. The first cylinder, second cylinder, third cylinder, and fourth cylinder are arranged in that order. These cylinders are formed with combustion chambers 5a to 5d. The pistons 3 which are arranged at these cylinders are connected to connecting rods 45. The connecting rods 45 are connected to a crankshaft 46. The crankshaft 46 is supported at the cylinder block 2 to be able to freely rotate.

The variable volume devices in the present embodiment include gas springs 50a to 50d. The gas springs 50a to 50d are connected at the cylinders to the combustion chambers 5a to 5d. The internal combustion engine in the present embodiment changes in volumes of the sub chambers 60 which are communicated with the combustion chambers 5a to 5d.

The gas springs 50a to 50b are connected to the gas tanks 90. One gas spring is connected to one gas tank 90. At the inlets and outlets of the gas tanks 90, pressure regulators 85 and the shutoff valves 86 are arranged. The internal combustion engine in the present embodiment is provided with a pressure changing device which changes the pressures of the compression spaces of the gas springs 50a to 50b. The pressure changing device in the present embodiment changes the pressures of the gas chambers 61 and gas tanks 90 of the gas springs 50a to 50d.

In the internal combustion engine of the present embodiment, the pressure changing device includes a compressor 72. If a pressure regulator 85 and a shutoff valve 86 are opened during the time period of movement of a sub chamber-use piston 55, sometimes the pressure of the gas chamber 61 is affected by the operating state of the compressor 72. Further, the pressure of the gas chamber 61 of one cylinder is sometimes affected by the pressure fluctuations due to operation of the gas spring of another cylinder. Further, the pressure of a gas chamber 61 is sometimes affected by acoustic vibration of the pipe of the pressure changing device etc.

In this way, the pressure of a gas chamber 61 of a gas spring 50 is sometimes affected by the pressure changing device. Further, in an internal combustion engine having a plurality of cylinders, the operations of the plurality of gas springs sometimes together affect the pressures of the gas chambers 61.

In the internal combustion engine of the present embodiment, at the cylinders, in the time period during which the sub chamber-use pistons 55 are moving, that is, in the time period during which the gas springs 50a to 50d are compressed, control is performed to isolate the gas springs 50a to 50d. In the present embodiment, the pressure regulators 85 function as isolation valves which isolate the gas springs 50a to 50d. In the time period during which the gas springs are compressed, control is performed to close the pressure regulators 85. By performing such control, the effect of pressure fluctuations from the pressure changing device can be suppressed.

Further, in the internal combustion engine of the present embodiment, at the cylinders, pressure regulators 85 are arranged which are able to isolate the gas springs 50a to 50d. For this reason, at the gas springs, it is possible to perform control to close the corresponding pressure regulators 85 during the time period during which the gas springs are compressed. By employing this configuration, it is possible to suppress the effect of the fluctuation of pressure due to operation of the gas springs of other cylinders. Further, it is possible to suppress the effects of acoustic vibration inside of the pipes etc.

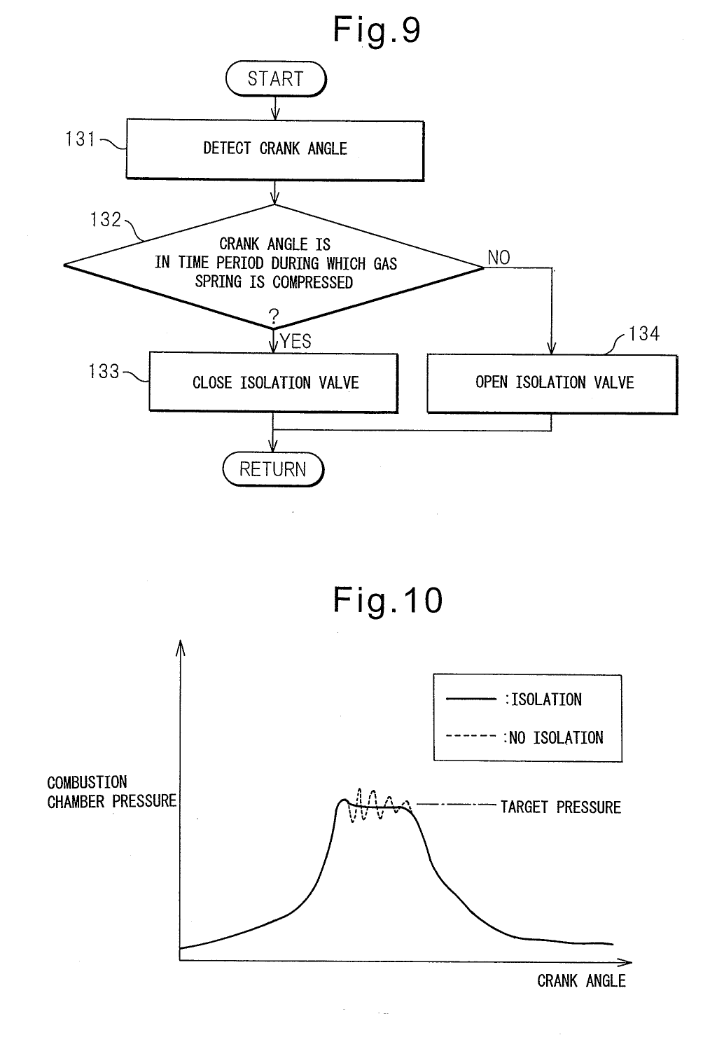

FIG. 9 shows a flow chart of operational control of the internal combustion engine in the present embodiment. The operational control shown in FIG. 9 can, for example, be performed for each cylinder. Further, it may be performed for each predetermined crank angle.

First, at step 131, the crank angle of the internal combustion engine is detected.

Next, at step 132, it is judged if the detected crank angle is in a time period during when the gas spring is compressed. That is, it is judged if it is the operating period of the variable volume device. When at step 132 the detected crank angle is in the time period during which the gas spring is compressed, the routine proceeds to step 133. Further, when, at step 132, the crank angle is not in the time period during which the gas spring is compressed, the routine proceeds to step 134. In the selection of the time period during which the gas spring is compressed, it is also possible to select the time period during which the sub chamber-use piston moves plus an extra time period.

At step 133, the isolation valve of the gas spring is closed. In the present embodiment, the pressure regulator 85 is closed. In the case of the state where the pressure regulator 85 is already closed, control is performed to maintain that state.

At step 134, control is performed to open the isolation valve. In the present embodiment, control is performed to open the pressure regulator 85. When the pressure regulator 85 is already open, control is performed to maintain that state.

FIG. 10 shows a graph for explaining the pressure of the combustion chamber in one cylinder in the internal combustion engine in the present embodiment. The abscissa shows the crank angle, while the ordinate shows the pressure of the combustion chamber. A graph of the case when isolating the gas spring in the time period during which the gas spring is compressed and a graph of the case when not isolating the gas spring are shown.

When not isolating the gas spring, when the pressure of the combustion chamber reaches the target pressure, vibration of the pressure occurs. As opposed to this, if isolating the gas spring, vibration of the pressure of the combustion chamber can be suppressed. In this way, in the time period during which the gas spring is compressed, stable operation is possible by isolating the gas spring.

In the operational control of the present embodiment, outside the time period in which the gas spring is compressed, control is performed to open the isolation valve, but the invention is not limited to this. Any control may be performed. For example, it is also possible to use the pressure changing device to change the pressures of the gas tank and the gas chamber, then perform control to close the pressure regulator as an isolation valve.

Further, in the internal combustion engine of the present embodiment, a volume changing device including a gas tank is arranged, but the invention is not limited to this. It is also possible to perform control to isolate the gas spring in the present embodiment in an internal combustion engine in which no volume changing device is provided as well.

The rest of the configuration, action, and effects are similar to Embodiment 1, so the explanation will not be repeated here.

In the operational control in the above embodiments, it is possible to suitably change the order of the steps in accordance with need.

Further, the above embodiments may be suitably combined. In the above drawings, the same or corresponding parts are assigned the same reference signs. Note that the above embodiments are illustrations and do not limit the invention. Further, in the embodiments, the changes shown in the claims are included.

### REFERENCE SIGNS LIST

3 piston
5 combustion chamber
31 electronic control unit
40 accelerator pedal
41 load sensor
42 crank angle sensor
50 and 50a to 50d gas spring
51 tubular member
55 sub chamber-use piston
60 sub chamber
61 gas chamber
72 compressor
74 pressure sensor
84 air exhaust valve
85 pressure regulator
86 shutoff valve
90 gas tank

1. An internal combustion engine comprising:
a variable volume device which includes a gas spring which has elasticity due to a gas being compressed and which, when a pressure of a combustion chamber reaches a predetermined control pressure, uses a change in pressure of the combustion chamber as a drive source so that the gas spring is compressed whereby a volume of the combustion chamber or a volume of a space communicated with the combustion chamber changes;
a pressure changing device which changes a pressure of the gas of the gas spring; and
a volume changing device which changes a volume of a compression space in which the gas of the gas spring is compressed; wherein
an operating state of the internal combustion engine is used as the basis to estimate a combustion rate of fuel in the combustion chamber, and the pressure of the gas of the gas spring is reduced and the volume of the compression space is made smaller the larger the combustion rate of the fuel in the combustion chamber.

2. An internal combustion engine as set forth in claim 1, wherein
the engine detects the operating state of the international combustion engine, selects a target pressure which a combustion chamber should reach in accordance with the operating state, and
reduces the pressure of the gas of the gas spring so that a maximum value of the pressure of the combustion chamber becomes substantially the target pressure.

3. An internal combustion engine as set forth in claim 1, wherein
the variable volume device includes a tubular part which is communicated with the combustion chamber and a movement member which is arranged movably inside of the tubular part,
the movement member defines a space at the inside of the tubular part whereby a sub chamber is formed at the side facing the combustion chamber and whereby a gas chamber is formed as a compression space at the opposite side from the side facing the combustion chamber, and
the pressure changing device is connected to the gas spring so as to change the pressure of the gas chamber.

4. An internal combustion engine as set forth in claim 3, wherein
the volume changing device includes
a gas tank which is connected to the gas chamber and
a shutoff valve which is arranged in a flow path between the gas chamber and the gas tank,
the shutoff valve being operated to change the volume of the compression space of the gas spring.

5. An internal combustion engine as set forth in claim 1, wherein
the pressure changing device includes an isolation valve for isolating the gas spring, and
control is performed to close the isolation valve in the time period during which the gas spring is compressed.
